(19) United States
(12) Patent Application Publication
(10) Pub. No.: US 2010/0106424 A1
(43) Pub. Date: Apr. 29, 2010

(54) Device for Determining the State of a Biological Subject

(76) Inventors: Konstantin Georgievich Korotkov, Saint-Petersburg (RU); Svetlana Alexandrovna Korotkina, Saint Petersburg (RU); Ramiz Ragim-Ogly Jusubov, Saint Petersburg (RU)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/447,917

(22) PCT Filed: Oct. 31, 2006
(86) PCT No.: PCT/RU2006/000570

§ 371 Date: Apr. 30, 2009

(51) Int. Cl. G06F 19/00

(52) U.S. Cl. 702/19

(57) ABSTRACT

The invention relates to physics and can be used for determining the functional state of a biological object, for example, a human or an animal.

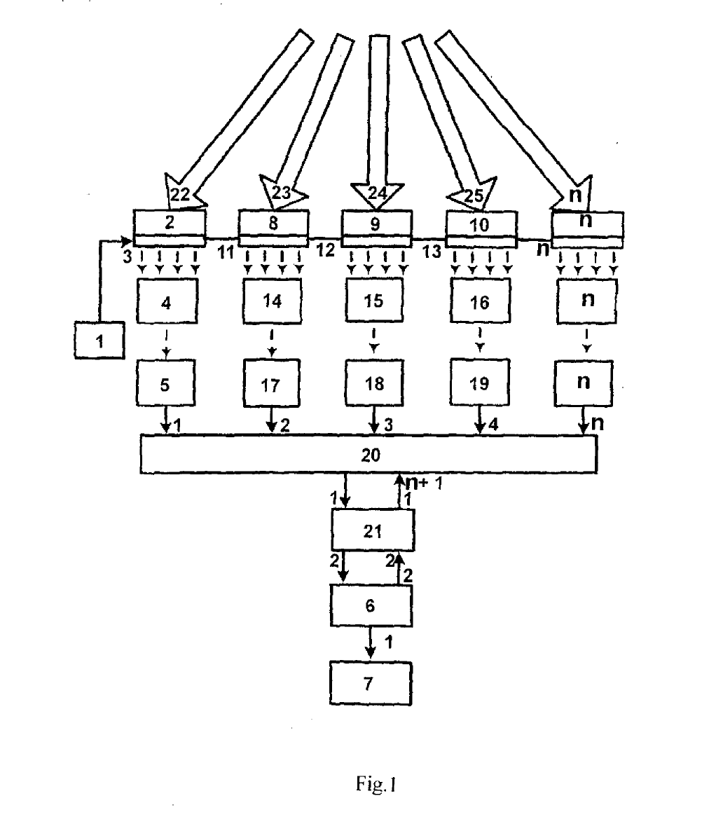

A device for determining the state of a biological subject, comprising an electric pulse generator, a transparent plate provided with an electrode which is embodied as an optically transparent conductive layer applied upon said plate, an objective, an optoelectronic digital converter, a computer and an information display unit, wherein the output of the generator is connected to the electrode, and the first output of the computer is connected to the input of the information display unit, said device being provided with one or more additional transparent plates with electrodes applied upon them, one or more additional objectives, and one or more additional optoelectronic digital converters, wherein the amount of additional objectives and optoelectronic digital converters equals the amount of additional transparent plates with electrodes applied upon them, said device being additionally provided with a memory unit and a data management and exchange unit, wherein the electrodes of all transparent plates are interconnected, the outputs of the optoelectronic digital converters are respectively connected to the first, second, n-th inputs of the memory unit, the output of said memory unit being connected to the first input of the data management and exchange unit, while the first output of the data management and exchange unit is connected to the (n+1)-th input of the memory unit, and the second output of said data management and exchange unit is connected to the input of the computer, the second output of the computer being connected to the second input of the data management and exchange unit.

The device provides increased accuracy of the information on the state of a biological subject.

### TECHNICAL FIELD

The invention relates to physics and can be used for determining the functional state of a biological object, for example, a human or an animal.

### BACKGROUND ART

A known device for determining the state of a human organism comprises an electrode covered with a dielectric layer, whereupon a certain thermoplastic material is placed; said electrode is connected to a high-voltage pulse generator, see RU, 94012892, A1. Electric current flows through the circuit formed by the electrode-registering material (a thermoplastic polymer), the body of the patient and the ground, thus transferring the charge from the skin of the patient to the polymer within the area of contact of the finger and the polymer. When the finger is removed from the circuit, the registering material is removed from the electrode and heated to 75-80° C., whereupon the polymer layer becomes deformed at those places where its surface holds surplus charge. Visualization of said deformations (the polymer layer's relief) produces an image that looks like a set of streamers coming out of the border of the area where the finger contacts the polymer. Medium length of charge streamers is used as a criterion of norm for a given patient. The device allows registering the charge streamers from all fingertips one by one.

The general state of the organism can be evaluated by comparing the characteristics of streamers from different fingers of the individual.

The main disadvantage of the abovementioned device consists in that it provides a very inaccurate evaluation of the individual's state, since it does not allow obtaining any quantitative information on the parameters of the images, making it impossible to compare images taken at different points of time. Analysis and comparison of the images is performed by an expert on the basis of his/her subjective visual assessments.

Another known device for determining the state of a biological subject is described in RU, 2141250, C. This device is taken as a prototype of the present invention.

Said device comprises a generator, a transparent plate provided with an electrode which is embodied as an optically transparent layer applied upon said plate, an objective, an optoelectronic digital converter, a computer and an information display unit embodied as a monitor. The output of the generator is connected to the electrode, while the output of the computer is connected to the input of the information display unit.

Said generator supplies electric pulses to the electrode, thus creating an electromagnetic field on the surface of said transparent plate.

A reference biological subject—finger of a healthy individual—contacts with the surface of said transparent plate. The electromagnetic field produces gas discharge glow around said reference biological subject. This glow is transferred through the objective to the optoelectronic digital converter, where it becomes converted to a digital code. The signal from the output of the optoelectronic digital converter is supplied to the input of the computer, whereupon the quantitative characteristics of structure of the gas discharge glow around the reference biological subject are determined; the parameters that reflect the two-dimensional geometric characteristics of the glow structures and the brightness characteristics are determined. The gas discharge glow around the reference subject can be represented on the monitor of the computer as a two-dimensional colored image.

Then the computer represents the whole assembly of the quantitative parameters as a three-dimensional point.

The gas discharge glow around the subject under study is represented in the same way, and a three-dimensional point that corresponds to the subject under study is also defined. The distance between these two points reflects the deviation of state of the subject under study from the reference subject.

The disadvantage of the prototype consists in the following.

At a given point of time, the device allows obtaining information from only one point of the biological subject, in particular, from one finger. Such information, however, gives only a partial evaluation of the subject's state. Therefore, in order to obtain larger volume of more detailed information, the data is taken from two, three or more fingers one by one (preferable, from all ten fingers and ten toes), because every finger or toe is associated with some organs or systems (see Korotkov K. G. Human Energy Field: study with GDV bioelectrography. SPb, 2001, pp. 40-45).

Information from a single finger can be taken within 1 to 10 seconds, depending on the mode chosen by the operator (static or dynamic). Total consecutive recording time for all ten fingers, including the time required for swapping the fingers, is at least 3-5 minutes on the average. During this time the state of the patient can change, because the electric field pulses excite the vegetative nervous sympathetic and parasympathetic systems, and the results of the measurements can therefore become severely distorted. It is practically impossible to perform simultaneous registration and computer transfer of GDV-information taken from several fingers, let alone all fingers and toes of the biological subject, for the following reasons. A single GDV-image taken from one point of a biological subject constitutes a significant amount of data (up to 40.0 megabytes), since it has a lot of details in a wide spectral optical range, both within the visible and the ultraviolet regions. GDV-images are taken with a frequency of at least 30 frames per second. Therefore, one point of the biological subject provides about 72 gigabytes of data, which is transferred to present-day computers at 1.2 GB/sec speed (40.0 MB×30 l/sec). When GDV-information is taken from two, let alone three points, the volume of data reaches or even exceeds the maximum capacities of modern computer equipment available for use. Thus, although those skilled in the art of GDV-technique (there are very few such people in the world) long ago realized is that the accuracy of determination of a biological subject's state can be significantly increased by registering information from two or more points (up to 20 points), they could not perform such experiments in practice, because there were no available computers capable of receiving and processing those huge amounts of data; besides, when big amounts of data are consecutively transferred through a USB port of an ordinary computer (NASA supercomputers are out of the question) during registration of the images, there is a strong probability of errors in computer operation that could lead to loss of data and require repetition of the registrations; that would in turn serve to additionally increase the distortion of information regarding the state of the biological object.

### SUMMARY OF THE INVENTION

It is an object of this invention to provide a solution capable of processing massive amounts of data (720 GB or more) that are collected when recording information from 10 or more points of the biological subject, thus providing a tenfold increase of accuracy of the information regarding the biological subject's state, while using existing easily available computer equipment.

According to the invention there is provided a device for determining the state of a biological subject, comprising an electric pulse generator, a transparent plate provided with an electrode which is embodied as an optically transparent conductive layer applied upon said plate, an objective, an optoelectronic digital converter, a computer and an information display unit, the output of said generator being connected to the electrode, and the first output of the computer being connected to the input of the information display unit, wherein said device is provided with one or more additional transparent plates with electrodes applied upon them, one or more additional objectives, and one or more additional optoelectronic digital converters, the amount of additional objectives and optoelectronic digital converters equaling the amount of additional transparent plates with electrodes applied upon them, and wherein said device is additionally provided with a memory unit and a data management and exchange unit, and wherein the electrodes of all transparent plates are interconnected, the outputs of the optoelectronic digital converters are respectively connected to the first, second, n-th inputs of the memory unit, the output of said memory unit being connected to the first input of the data management and exchange unit, whereas the first output of the data management and exchange unit is connected to the (n+1)-th input of the memory unit, and the second output of said data management and exchange unit is connected to the input of the computer, while the second output of the computer is connected to the second input of the data management and exchange unit.

The applicant hasn't found any sources of information containing data on engineering solutions identical to the present invention. In applicant's opinion, this enables to conclude that the invention conforms to the criterion “Novelty” (N).

The novel features of the invention provide the device with an important new property, which makes it possible to record information from any required amount of points in a single step, thus ensuring that the subject is participating in the measurements during 1 to 10 seconds only. Furthermore, the data transfer channel does not become overloaded, because the information recorded from the subject first goes to the memory unit, whereupon it is extracted by the data management and exchange unit and supplied to the computer through a USB port with normal transfer rate; this prevents distortion of the information, both when it is received from the subject and during its transfer; also it becomes possible to employ computer equipment that is widely used in practice.

The applicant hasn't found any sources of information containing data on the influence of the inventive novel features on the technical result produced through realization of said features. In applicant's opinion, this enables to conclude that the present engineering solution conforms to the criterion “Inventive Step” (IS).

### BRIEF DESCRIPTION OF THE DRAWINGS

The invention is further explained, by way of example, with reference to a drawing, which is a block diagram of the device.

### DETAILED DESCRIPTION OF THE PREFERRED EMBODIMENT

The device for determining the state of a biological subject, in this particular embodiment an individual, comprises a generator 1 of electric pulses with amplitude of 10-20 kV, duration of 10 μsec and pulse ratio of 1000 Hz, wherein the pulses are served in 0.5 sec bursts. This particular embodiment uses the generator “Corona” manufactured by a Russian company “Kirlionics Technologies International” LLC (St. Petersburg). The information is taken from n points. The device comprises transparent plates 2, 8, 9, 10, . . . , n. The plates are respectively provided with electrodes 3, 11, 12, 13, . . . , n, embodied as layers of some optically transparent conductive material applied to said plates (in this particular embodiment, a 200 μm deep layer of SnO₂ is used). The objectives 4, 14, 15, 16, . . . , n are positioned under the transparent plates, respectively. The objectives are optically conjugated with the optoelectronic digital converters 5, 17, 18, 19, . . . , n, respectively. The optoelectronic digital converters constitute an array structure embodied on the basis of a charge-coupled device (CCD-structure).

The output of the generator 1 is connected to the electrode 3, and the electrodes 3, 11, 12, 13, . . . , n, are interconnected. The outputs of the optoelectronic digital converters 5, 17, 18, 19, . . . , n are respectively connected to the first, second, third, fourth, n-th inputs of the memory unit 20, which is embodied on the basis of BS62LV4001-TI chip manufactured by Texas Instruments (USA). The output of the memory unit 20 is connected to the first input of the data management and exchange unit 21, which is embodied on the basis of C8051F320 chip manufactured by Silicon Labs (USA). The first output of the unit 21 is connected to the (n+1)-th input of the unit 20. The second output of the unit 21 is connected to the input of the computer 6, the first output of the computer 6 being connected to the input of the information display unit 7 (a monitor). The second output of the computer 6 is connected to the second input of the unit 21.

The device operates in the following way. The points under study 22, 23, 24, 25, . . . , n (the fingers and/or toes of the individual) are simultaneously positioned on the free surfaces of the TRANSPARENT plates 2, 8, 9, 10, n, whereupon the generator 1 supplies voltage pulses to the electrodes 3, 11, 12, 13, . . . , n, thus creating an electromagnetic field with intensity of 10⁶-10⁸ V/cm. The glow that is produced around the fingers enters the objectives 4, 14, 15, 16, . . . , n simultaneously, and then it proceeds through the objectives to the inputs of the optoelectronic digital converters 5, 17, 18, 19, . . . , n, whereupon the digital signals from the outputs of said optoelectronic digital converters enter corresponding inputs of the memory unit 20 in a single step, where they are saved as digital files. At a certain time point, which is defined by the operator by a control command that is sent from the data management and exchange unit 21, the digital files stored in the memory unit 20 are transferred to the computer 6 for subsequent processing and analysis in the normal mode, which is determined by the technical characteristics of the computer 6 and the data management and exchange unit 21. Said digital files can be stored in the memory unit 20 until the data management and exchange unit 21 issues a command to erase them, which guarantees accuracy of storage and transfer of large amounts of data regardless of the technical characteristics of the data transfer channel between the computer 6 and the data management and exchange unit 21. Single-step registration of the glow from all plates 2, 8, 9, 10, . . . , n ensures accuracy of analysis of the patient in its undisturbed state.

### INDUSTRIAL APPLICABILITY

Realization of the invention can be done by means of known technologies and standard equipment. In applicant's opinion, this enables to conclude that the invention conforms to the criterion “Industrial Applicability” (IA).

1. A device for determining the state of a biological subject, comprising an electric pulse generator, a transparent plate provided with an electrode which is embodied as an optically transparent conductive layer applied upon said plate, an objective, an optoelectronic digital converter, a computer and an information display unit, wherein the output of the generator is connected to the electrode, and the first output of the computer is connected to the input of the information display unit, characterized in that said device is provided with one or more additional transparent plates with electrodes applied upon them, one or more additional objectives and one or more additional optoelectronic digital converters, wherein the amount of additional objectives and optoelectronic digital converters equals the amount of additional transparent plates with electrodes applied upon them, said device being additionally provided with a memory unit and a data management and exchange unit, and wherein the electrodes of all transparent plates are interconnected, the outputs of the optoelectronic digital converters are respectively connected to the first, second, n-th inputs of the memory unit, the output of said memory unit being connected to the first input of the data management and exchange unit, while the first output of the data management and exchange unit is connected to the (n+1)-th input of the memory unit, and the second output is connected to the input of the computer, while the second output of the computer is connected to the second input of the data management and exchange unit.

2. A device for determining the state of a biological subject, comprising:
an electric pulse generator;
a first transparent plate provided with an electrode;
one or more additional transparent plates with electrodes applied upon them,
a first objective;
one or more additional objectives equaling the amount of additional transparent plates with electrodes applied upon them;
an optoelectronic digital converter;
one or more additional optoelectronic digital converter equaling the amount of additional transparent plates with electrodes applied upon them;
a computer having an information display unit;
wherein an output of the generator is operatively connected to the electrode, and a first output of the computer is operatively connected to the input of the information display unit and said device being additionally provided with a memory unit and a data management and exchange unit, and wherein the electrodes of all transparent plates are interconnected, the outputs of the optoelectronic digital converters are respectively connected to the first, second, n-th inputs of the memory unit, the output of said memory unit being connected to the first input of the data management and exchange unit, while the first output of the data management and exchange unit is connected to the (n+1)-th input of the memory unit, and the second output is connected to the input of the computer, while the second output of the computer is connected to the second input of the data management and exchange unit.

3. The device for determining the state of a biological subject of claim 2, wherein each said electrode comprise an optically transparent conductive layer applied upon said plate.
